(19) United States
(12) Patent Application Publication
(10) Pub. No.: US 2023/0149816 A1
(43) Pub. Date: May 18, 2023

(54) METHOD FOR PROVIDING BATTLE ROYALE GAME IN WHICH AT LEAST PART OF ITEM TYPE AND ITEM PERFORMANCE IS CHANGED BY REFERRING TO GAME-PROGRESSION DEGREE AND SERVER USING THE SAME

(71) Applicant: Wonder People Co., Ltd., Seoul (KR)

(72) Inventor: Min HUR, Seoul (KR)

(21) Appl. No.: 17/975,774

(22) Filed: Oct. 28, 2022

(30) Foreign Application Priority Data
Nov. 15, 2021 (KR) 10-2021-0157121
Jun. 16, 2022 (KR) 10-2022-0073833

(51) Int. Cl. A63F 13/58; A63F 13/537; A63F 13/35

(52) U.S. Cl. CPC A63F 13/58; A63F 13/537; A63F 13/35; A63F 2300/65; A63F 2300/303

(57) ABSTRACT

A method of providing a battle royale game allows item types and item performances to be changed by referring to a game-progression degree. The method includes steps of: (a) checking specific item type candidates and their corresponding specific item type probabilities, and specific item performance candidates and their corresponding specific item performance probabilities corresponding to the specific game-progression degree; and (b) changing the item types or the item performances of the battle royale game by referring to at least part of (i) specific item types calculated by using a predetermined first function whose arguments include the specific item type candidates and their corresponding specific item type probabilities and (ii) specific item performances calculated by using a predetermined second function whose arguments include the specific item performance candidates and their corresponding specific item performance probabilities.

### CROSS REFERENCE TO RELATED APPLICATION

This application claims the benefit of priority to Korean Provisional Patent Application No. 10-2021-0157121, filed on Nov. 15, 2021, and Korean Non-provisional Patent Application No. 10-2022-0073833, filed on Jun. 16, 2022, the entire contents of which being incorporated herein by reference.

### FIELD OF THE DISCLOSURE

The present disclosure relates to a method for providing a battle royale game and a server using the same; and more particularly, to the method for providing the battle royale game in which at least part of one or more item types and item performances are changed by referring to a game-progression degree.

### BACKGROUND OF THE DISCLOSURE

Numerous battle royale games which can be played by multiple users at the same time are recently being released and are gaining popularity steadily from the users.

Such battle royale games are allowing the multiple players to compete for survival to be a final winner in a restricted space, and the users feel interest in preoccupying geographical advantages and items and establishing appropriate strategies or tactics according thereto, thereby overpowering competitors.

However, since strategies/tactics of the conventional battle royale game are fixed to an extent, for example, in a limited map with a predetermined number of players, there are frequent cases of only using 2-3 types of specific weapons among dozens of weapons provided in the battle royale game known to provide good performance.

As such, there is a problem of the users of the battle royale game losing their interests because of simplified game strategies due to repeated use of the specific weapons, thus resulting in a decrease replayability of the battle royale game.

Therefore, an improvement for solving these problems is required.

### SUMMARY OF THE DISCLOSURE

It is an object of the present disclosure to solve all the aforementioned problems.

It is another object of the present disclosure to provide a battle royale game capable of allowing at least part of one or more item types and item performances to be changed by referring to a game-progression degree.

It is still another object of the present disclosure to enable users of the battle royale game to continuously have interests in the battle royale game.

In order to accomplish objects above and characteristic effects to be described later of the present disclosure, distinctive structures of the present disclosure are described as follows.

In accordance with one aspect of the present disclosure, there is provided a method of providing a battle royale game capable of allowing at least part of one or more item types and item performances to be changed by referring to a game-progression degree, wherein the battle royale game is a game in which a plurality of players compete for survival in a specific area, wherein a first state of the battle royale game represents a standby state in which the players log into the battle royale game and wait in a same waiting space and wherein a second state of the battle royale game represents a state in which the players play the battle royale game, including steps of: (a) on condition that at least part of respective item type candidates and their corresponding item type probabilities, and respective item performance candidates and their corresponding item performance probabilities for each game-progression degree have been set and managed, wherein the game-progression degree is calculated by using a progress calculating function whose arguments include at least part of (i) elapsed time information which represents a time elapsed after the battle royale game enters the second state, (ii) player battle power information which represents battle powers of at least part of the plurality of players, (iii) a cardinal number of surviving players among the plurality of players, (iv) area phase information which represents a state of a safe area and a dangerous area being changed according to area metadata, and (v) possessed items of the surviving players, in response to detecting that a specific game-progression degree acquired by using the progress calculating function in real-time at the second state satisfies a predetermined condition, a server checking at least part of specific item type candidates and their corresponding specific item type probabilities, and specific item performance candidates and their corresponding specific item performance probabilities corresponding to the specific game-progression degree; and (b) the server changing at least part of the item types or the item performances of the battle royale game by referring to at least part of (i) specific item types calculated by using a predetermined first function whose arguments include the specific item type candidates and their corresponding specific item type probabilities and (ii) specific item performances calculated by using a predetermined second function whose arguments include the specific item performance candidates and their corresponding specific item performance probabilities.

As one example, at the step of (a), on condition that the server has managed each of a 1-st game-progression degree to an m-th game-progression degree for each of a 1-st area to an m-th area respectively, wherein the 1-st area to the m-th area are acquired by dividing an entire area including the safe area and the dangerous area based on geographical information, and has set and managed at least part of (i) 1-st item type candidates to m-th item type candidates and their corresponding 1-st item type probabilities to m-th item type probabilities for the 1-st area to the m-th area respectively, and (ii) 1-st item performance candidates to m-th item performance candidates and their corresponding 1-st item performance probabilities to m-th item performance probabilities for the 1-st area to the m-th area respectively, the server, in response to determining that at least part of a 1-st specific game-progression degree to an m-th specific game-progression degree acquired by using the progress calculating function in real-time at the second state satisfies at least part of a 1-st predetermined condition to an m-th predetermined condition respectively, checks at least part of (1) 1-st specific item type candidates to m-th specific item type candidates and their corresponding 1-st specific item type probabilities to m-th specific item type probabilities for the 1-st area to the m-th area respectively, and (2) 1-st specific item performance candidates to m-th specific item performance candidates and their corresponding 1-st specific item performance probabilities to m-th specific item performance probabilities for the 1-st area to the m-th area respectively, wherein the 1-st area to the m-th area are respectively matched with the 1-st specific game-progression degree to the m-th specific game-progression degree, and wherein, at the step of (b), the server refers to at least part of (i) 1-st specific item types to m-th specific item types which are respectively acquired by using a predetermined (1_1)-st function whose arguments are the 1-st specific item type candidates and their corresponding 1-st specific item type probabilities to a predetermined (1_m)-th function whose arguments are the m-th specific item type candidates and their corresponding m-th specific item type probabilities, and (ii) 1-st specific item performances to m-th specific item performances which are respectively acquired by using a predetermined (2_1)-st function whose arguments are the 1-st specific item performance candidates and their corresponding 1-st specific item performance probabilities to a predetermined (2_m)-th function whose arguments are the m-th specific item performance candidates and their corresponding m-th specific item performance probabilities, to thereby change at least part of the item types and the item performances.

As one example, each of the 1-st specific game-progression degree to the m-th specific game-progression degree for each of the 1-st area to the m-th area is calculated by using the progress calculating function whose arguments are at least part of (i) each of 1-st specific elapsed time information to m-th specific elapsed time information, (ii) each of 1-st specific player battle power information to m-th specific player battle power information, (iii) each of a 1-st cardinal number of surviving players to an m-th cardinal number of surviving players, (iv) each of 1-st specific area phase information to m-th specific area phase information, and (v) 1-st specific possessed items of the surviving players to m-th specific possessed items of the surviving players.

As one example, at the step of (b), the server changes at least part of the item types and the item performances used within the battle royale game by referring to at least part of the specific item types and the specific item performances, wherein the server changes the item types and item performances of one or more k-th class synergy items corresponding to a k-th surviving player group, which satisfies a threshold condition of surviving players, among a 1-st surviving player group to an n-th surviving player group, wherein the 1-st surviving player group to the n-th surviving player group are determined by dividing the surviving players based on at least part of classes applied thereto and the possessed items thereof, and wherein the k-th class synergy items are items capable of amplifying the item performances when used by a corresponding k-th surviving player with a k-th class.

As one example, at the step of (a), on condition that at least part of metadata related to a 1-st weight, a 2-nd weight, a 3-rd weight, a 4-th weight, and a 5-th weight has been managed, wherein the 1-st weight is applied to the elapsed time information, the 2-nd weight is applied to the player battle power information, the 3-rd weight is applied to the area phase information, the 4-th weight is applied to the cardinal number of the surviving players, and the 5-th weight is applied to the possessed items of the surviving players, in response to determining that a weighted specific game-progression degree satisfies the predetermined condition, wherein the weighted specific game-progression degree is acquired from the progress calculating function in real-time at the second state by applying at least part of the 1-st weight to the 5-th weight to the elapsed time information, the player battle power information, the area phase information, the cardinal number of surviving players, and the possessed items of the surviving players corresponding to specific game-progression degree, the server checks at least part of (i) the specific item type candidates and their corresponding specific item type probabilities, and (ii) the specific item performance candidates and their corresponding specific item performance probabilities that are matched with the weighted specific game-progression degree.

As one example, at the step of (a), the server (i) determines a specific factor, among entire factors, whose rate of change within a specific time period is greater than or equal to a threshold rate of change, wherein the specific time period, among a plurality of predetermined time periods, corresponds to a specific time point when the specific game-progression degree is acquired, and (ii) sets a specific weight corresponding to the specific factor to be greater than other weights corresponding to other factors, wherein said other factors are factors excluding the specific factor among the entire factors, and wherein the entire factors include the player battle power information, the area phase information, the cardinal number of surviving players, and the possessed items of the surviving players.

As one example, at the step of (b), the server changes at least part of the item types and the item performances of one or more items used within the battle royale game by referring to at least part of the specific item types and the specific item performances, wherein, the server transmits at least part of item type changed information and item performance changed information to a specific user device of a specific surviving player, to thereby instruct the specific user device to display at least part of the item type changed information and the item performance changed information onto at least part of (i) a 1-st display area for displaying azimuth information, (ii) a 2-nd display area for displaying field location information of the specific surviving player, (iii) a 3-rd display area for displaying map location information of the specific surviving player, and (iv) a 4-th display area for displaying a specific possessed item of the specific surviving player.

In accordance with another aspect of the present disclosure, there is provided a server of providing a battle royale game capable of allowing at least part of one or more item types and item performances to be changed by referring to a game-progression degree, wherein the battle royale game is a game in which a plurality of players compete for survival in a specific area, wherein a first state of the battle royale game represents a standby state in which the players log into the battle royale game and wait in a same waiting space and wherein a second state of the battle royale game represents a state in which the players play the battle royale game, including: at least one memory that stores instructions; and at least one processor configured to execute the instructions to perform or support another device to perform processes of: (I) on condition that at least part of respective item type candidates and their corresponding item type probabilities, and respective item performance candidates and their corresponding item performance probabilities for each game-progression degree have been set and managed, wherein the game-progression degree is calculated by using a progress calculating function whose arguments include at least part of (i) elapsed time information which represents a time elapsed after the battle royale game enters the second state, (ii) player battle power information which represents battle powers of at least part of the plurality of players, (iii) a cardinal number of surviving players among the plurality of players, (iv) area phase information which represents a state of a safe area and a dangerous area being changed according to area metadata, and (v) possessed items of the surviving players, in response to detecting that a specific game-progression degree acquired by using the progress calculating function in real-time at the second state satisfies a predetermined condition, checking at least part of specific item type candidates and their corresponding specific item type probabilities, and specific item performance candidates and their corresponding specific item performance probabilities corresponding to the specific game-progression degree; and (II) changing at least part of the item types or the item performances of the battle royale game by referring to at least part of (i) specific item types calculated by using a predetermined first function whose arguments include the specific item type candidates and their corresponding specific item type probabilities and (ii) specific item performances calculated by using a predetermined second function whose arguments include the specific item performance candidates and their corresponding specific item performance probabilities.

As one example, at the process of (I), on condition that the processor has managed each of a 1-st game-progression degree to an m-th game-progression degree for each of a 1-st area to an m-th area respectively, wherein the 1-st area to the m-th area are acquired by dividing an entire area including the safe area and the dangerous area based on geographical information, and has set and managed at least part of (i) 1-st item type candidates to m-th item type candidates and their corresponding 1-st item type probabilities to m-th item type probabilities for the 1-st area to the m-th area respectively, and (ii) 1-st item performance candidates to m-th item performance candidates and their corresponding 1-st item performance probabilities to m-th item performance probabilities for the 1-st area to the m-th area respectively, the processor, in response to determining that at least part of a 1-st specific game-progression degree to an m-th specific game-progression degree acquired by using the progress calculating function in real-time at the second state satisfies at least part of a 1-st predetermined condition to an m-th predetermined condition respectively, checks at least part of (1) 1-st specific item type candidates to m-th specific item type candidates and their corresponding 1-st specific item type probabilities to m-th specific item type probabilities for the 1-st area to the m-th area respectively, and (2) 1-st specific item performance candidates to m-th specific item performance candidates and their corresponding 1-st specific item performance probabilities to m-th specific item performance probabilities for the 1-st area to the m-th area respectively, wherein the 1-st area to the m-th area are respectively matched with the 1-st specific game-progression degree to the m-th specific game-progression degree, and wherein, at the step of (II), the processor refers to at least part of (i) 1-st specific item types to m-th specific item types which are respectively acquired by using a predetermined (1_1)-st function whose arguments are the 1-st specific item type candidates and their corresponding 1-st specific item type probabilities to a predetermined (1_m)-th function whose arguments are the m-th specific item type candidates and their corresponding m-th specific item type probabilities, and (ii) 1-st specific item performances to m-th specific item performances which are respectively acquired by using a predetermined (2_1)-st function whose arguments are the 1-st specific item performance candidates and their corresponding 1-st specific item performance probabilities to a predetermined (2_m)-th function whose arguments are the m-th specific item performance candidates and their corresponding m-th specific item performance probabilities, to thereby change at least part of the item types and the item performances.

As one example, each of the 1-st specific game-progression degree to the m-th specific game-progression degree for each of the 1-st area to the m-th area is calculated by using the progress calculating function whose arguments are at least part of (i) each of 1-st specific elapsed time information to m-th specific elapsed time information, (ii) each of 1-st specific player battle power information to m-th specific player battle power information, (iii) each of a 1-st cardinal number of surviving players to an m-th cardinal number of surviving players, (iv) each of 1-st specific area phase information to m-th specific area phase information, and (v) 1-st specific possessed items of the surviving players to m-th specific possessed items of the surviving players.

As one example, at the process of (II), the processor changes at least part of the item types and the item performances used within the battle royale game by referring to at least part of the specific item types and the specific item performances, wherein the processor changes the item types and item performances of one or more k-th class synergy items corresponding to a k-th surviving player group, which satisfies a threshold condition of surviving players, among a 1-st surviving player group to an n-th surviving player group, wherein the 1-st surviving player group to the n-th surviving player group are determined by dividing the surviving players based on at least part of classes applied thereto and the possessed items thereof, and wherein the k-th class synergy items are items capable of amplifying the item performances when used by a corresponding k-th surviving player with a k-th class.

As one example, at the process of (I), on condition that at least part of metadata related to a 1-st weight, a 2-nd weight, a 3-rd weight, a 4-th weight, and a 5-th weight has been managed, wherein the 1-st weight is applied to the elapsed time information, the 2-nd weight is applied to the player battle power information, the 3-rd weight is applied to the area phase information, the 4-th weight is applied to the cardinal number of the surviving players, and the 5-th weight is applied to the possessed items of the surviving players, in response to determining that a weighted specific game-progression degree satisfies the predetermined condition, wherein the weighted specific game-progression degree is acquired from the progress calculating function in real-time at the second state by applying at least part of the 1-st weight to the 5-th weight to the elapsed time information, the player battle power information, the area phase information, the cardinal number of surviving players, and the possessed items of the surviving players corresponding to specific game-progression degree, the processor checks at least part of (i) the specific item type candidates and their corresponding specific item type probabilities, and (ii) the specific item performance candidates and their corresponding specific item performance probabilities that are matched with the weighted specific game-progression degree.

As one example, at the process of (I), the processor (i) determines a specific factor, among entire factors, whose rate of change within a specific time period is greater than or equal to a threshold rate of change, wherein the specific time period, among a plurality of predetermined time periods, corresponds to a specific time point when the specific game-progression degree is acquired, and (ii) sets a specific weight corresponding to the specific factor to be greater than other weights corresponding to other factors, wherein said other factors are factors excluding the specific factor among the entire factors, and wherein the entire factors include the player battle power information, the area phase information, the cardinal number of surviving players, and the possessed items of the surviving players.

As one example, at the process of (II), the processor changes at least part of the item types and the item performances of one or more items used within the battle royale game by referring to at least part of the specific item types and the specific item performances, wherein, the processor transmits at least part of item type changed information and item performance changed information to a specific user device of a specific surviving player, to thereby instruct the specific user device to display at least part of the item type changed information and the item performance changed information onto at least part of (i) a 1-st display area for displaying azimuth information, (ii) a 2-nd display area for displaying field location information of the specific surviving player, (iii) a 3-rd display area for displaying map location information of the specific surviving player, and (iv) a 4-th display area for displaying a specific possessed item of the specific surviving player.

### BRIEF DESCRIPTION OF THE DRAWINGS

The following drawings to be used for explaining example embodiments of the present disclosure are only part of example embodiments of the present disclosure and other drawings can be obtained based on the drawings by those skilled in the art of the present disclosure without inventive work.

FIG. 1 is a drawing schematically illustrating a server that provides a battle royale game capable of allowing at least part of one or more item types and item performances to be changed by referring to a game-progression degree in accordance with one example embodiment of the present disclosure.

FIG. 2 is a drawing schematically illustrating processes for providing the battle royale game capable of allowing the item types and the item performances to be changed by referring to the game-progression degree in accordance with one example embodiment of the present disclosure.

FIG. 3 is a drawing schematically illustrating a method of displaying the item types and the item performances changed during the battle royale game in accordance with one example embodiment of the present disclosure.

### DETAILED DESCRIPTION OF THE PREFERRED EMBODIMENTS

Detailed explanation on the present disclosure to be made below refer to attached drawings and diagrams illustrated as specific embodiment examples under which the present disclosure may be implemented to make clear of purposes, technical solutions, and advantages of the present disclosure. These embodiments are described in sufficient detail to enable those skilled in the art to practice the present disclosure.

Besides, in the detailed description and claims of the present disclosure, a term “include” and its variations are not intended to exclude other technical features, additions, components or steps. Other objects, benefits and features of the present disclosure will be revealed to those skilled in the art, partially from the specification and partially from the implementation of the present disclosure. The following examples and drawings will be provided as examples, but they are not intended to limit the present disclosure.

Moreover, the present disclosure covers all possible combinations of example embodiments indicated in this specification. It is to be understood that the various embodiments of the present disclosure, although different, are not necessarily mutually exclusive. For example, a particular feature, structure, or characteristic described herein in connection with one embodiment may be implemented within other embodiments without departing from the spirit and scope of the present disclosure. In addition, it is to be understood that the position or arrangement of individual elements within each disclosed embodiment may be modified without departing from the spirit and scope of the present disclosure. The following detailed description is, therefore, not to be taken in a limiting sense, and the scope of the present disclosure is defined only by the appended claims, appropriately interpreted, along with the full range of equivalents to which the claims are entitled. In the drawings, like numerals refer to the same or similar functionality throughout the several views.

To allow those skilled in the art to the present disclosure to be carried out easily, the example embodiments of the present disclosure by referring to attached diagrams will be explained in detail as shown below.

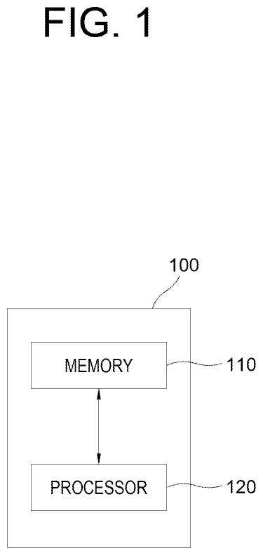

FIG. 1 is a drawing schematically illustrating a server 100 in accordance with one example embodiment of the present disclosure. Referring to FIG. 1, the server 100 may include a memory 110 for storing instructions to provide a battle royale game capable of allowing at least part of one or more item types and item performances to be changed by referring to a game-progression degree and a processor 120 for performing processes of changing the item types and the item performances by referring to the game-progression degree according to the instructions stored in the memory 110 in accordance with one example embodiment of the present disclosure.

Specifically, the server 100 may typically achieve a desired system performance by using combinations of at least one computing device such as a computer processor, a memory, a storage, an input device, an output device, or any other conventional computing components, at least one electronic communication device such as a router or a switch, at least one electronic information storage system such as a network-attached storage (NAS) device or a storage area network (SAN), and at least one computer software, i.e., any instructions that allow the computing device to function in a specific manner.

Also, the processors of such devices may include hardware configuration of MPU (Micro Processing Unit) or CPU (Central Processing Unit), cache memory, data bus, etc. Additionally, the computing device may further include operating system (OS) and software configuration of applications that achieve specific purposes.

Additionally, the computing device may further include operating system (OS) and software configuration of applications that achieve specific purposes.

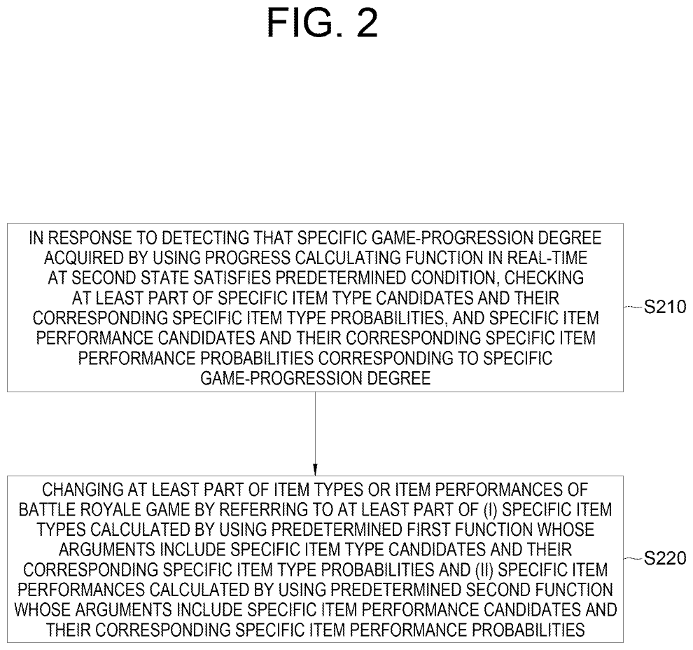

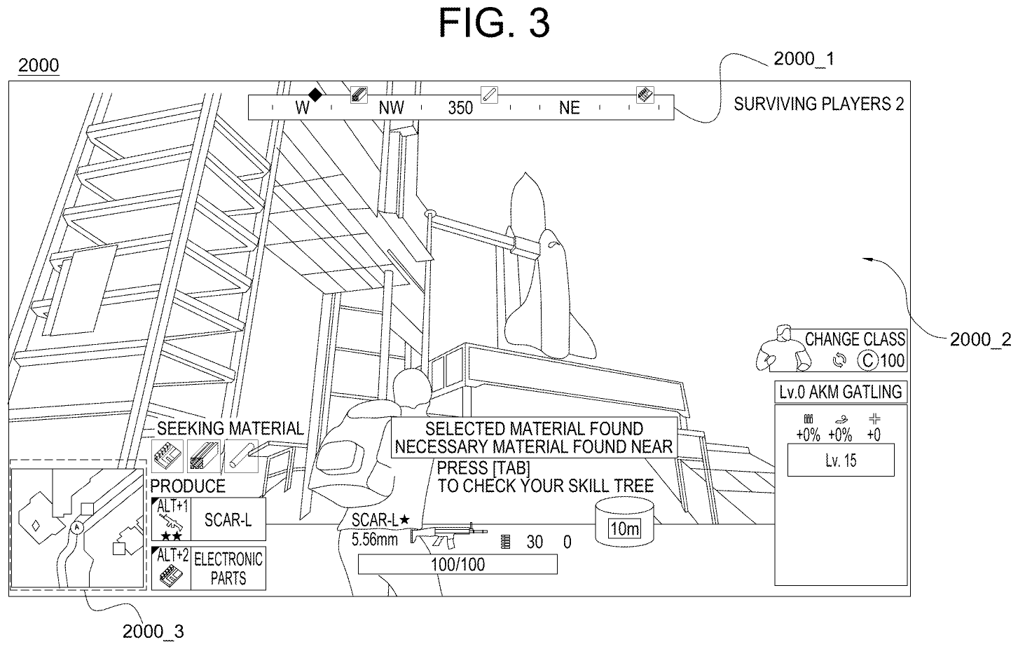

A method of using the server 100 as described above to perform processes of providing the battle royale game capable of allowing at least part of the item types and the item performances to be changed by referring to the game-progression degree will be explained with reference to FIGS. 2 and 3.

As used in this specification and the appended claims, the singular forms “a,” “an,” and “the” include plural referents, i.e., one or more, unless the content and context clearly dictates otherwise.

Hereinafter, a first state of the battle royale game may represent a standby state in which the players log into the battle royale game and wait in a same waiting space and a second state of the battle royale game may represent a state in which the players play the battle royale game.

FIG. 2 is a drawing schematically illustrating processes for providing the battle royale game capable of allowing the item types and the item performances to be changed by referring to the game-progression degree in accordance with one example embodiment of the present disclosure. To explain overall processes by referring to FIG. 2, the server 100, in response to detecting that a specific game-progression degree acquired by using a progress calculating function in real-time at the second state satisfies a predetermined condition, may check at least part of specific item type candidates and their corresponding specific item type probabilities, and specific item performance candidates and their corresponding specific item performance probabilities corresponding to the specific game-progression degree, at a step of S210, and may change at least part of the item types or the item performances of the battle royale game by referring to at least part of (i) specific item types calculated by using a predetermined first function whose arguments include the specific item type candidates and their corresponding specific item type probabilities and (ii) specific item performances calculated by using a predetermined second function whose arguments include the specific item performance candidates and their corresponding specific item performance probabilities, at a step of S220.

The processes of the server 100 providing the battle royale game capable of allowing the item types and the item performances to be changed in accordance with one example embodiment of the present disclosure have been described above, and more details thereof will be described below.

First, the server 100 may have set and managed at least part of (i) item type candidates and their corresponding item type probabilities for each game-progression degree and (ii) item performance candidates and their corresponding item performance probabilities for each game-progression degree.

Herein, the game-progression degree may be calculated by using the progress calculating function whose arguments include at least part of (i) elapsed time information which represents a time elapsed after the battle royale game enters the second state, (ii) player battle power information which represents battle powers of at least part of the plurality of players, (iii) a cardinal number of surviving players among the plurality of players, (iv) area phase information which represents a state of a safe area and a dangerous area being changed according to area metadata, and (v) possessed items of the surviving players.

As an example, if two minutes have elapsed since entering into the second state and the area phase information of the safe area and the dangerous area is at a first phase, the game-progression degree calculated by using the progress calculating function with arguments including at least part of the 2 minutes as the elapsed time information and the first phase as the area phase information may satisfy a triggering point that is needed for entering into a first stage. Herein, the word “stage” is used to conveniently represent the cardinal number of turns counted whenever the item types and the item performances are changed.

As another example, if 22 minutes have elapsed since entering into the second state and the area phase information of the safe area and the dangerous area is at a fifth phase, the game-progression degree calculated by using the progress calculating function with arguments including at least part of the 22 minutes as the elapsed time information and the fifth phase as the area phase information may satisfy the triggering point that is needed for entering into a ninth stage.

As an example, to further elaborate on the item type candidates and their corresponding item type probabilities set for each game-progression degree, (1_1)-st item type candidates (e.g., weapon A, weapon C, armor A, armor B) to (1_5)-th item type candidates (e.g., weapon A, weapon B, armor B, armor D) may be set as the item type candidates corresponding to the game-progression degree satisfying the triggering point that is needed to enter into the first stage or they may be set in real-time as the item type candidates corresponding to the game-progression degree satisfying the triggering point that is needed to enter into the first stage, such that they are selected from a predetermined time period which follows a time point of satisfying the triggering point that is needed to enter into the first stage. For example, (1_1)-st item type probabilities to (1_5)-th item type probabilities may be set as 0.15, 0.2, 0.4, 0.2, and 0.05, or they may be set in real-time. Further details related to the triggering point will be explained below.

As another example, it is possible to predict the time point of satisfying the triggering point that is needed to enter into the first stage. For example, the (1_1)-st item type candidates (e.g., weapon A, weapon C, armor A, armor B) to the (1_5)-th item type candidates (e.g., weapon A, weapon B, armor B, armor D) may be set as the item type candidates corresponding to the game-progression degree satisfying the triggering point that is needed to enter into the first stage or they may be set in real-time as the item type candidates corresponding to the game-progression degree satisfying the triggering point that is needed to enter into the first stage, such that they are selected from a predetermined time period which follows a predicted time point of satisfying the triggering point that is needed to enter into the first stage. For example, the (1_1)-st item type probabilities to the (1_5)-th item type probabilities may be set as 0, 0, 1, 0, and 0, or they may be set in real-time. It is noted that all probabilities may be set to be non-zeros.

As still another example, (9_1)-st item type candidates (e.g., weapon A, weapon D, armor B, armor E) to (9_4)-th item type candidates (e.g., weapon B, weapon D, armor C, armor E) may be set as the item type candidates corresponding to the game-progression degree satisfying the triggering point that is needed to enter into the ninth stage or they may be set in real-time as the item type candidates corresponding to the game-progression degree satisfying the triggering point that is needed to enter into the ninth stage, such that they are selected from a predetermined time period which follows a time point of satisfying the triggering point that is needed to enter into the ninth stage. For example (9_1)-st item type probabilities to (9_4)-th item type probabilities may be set as 0, 1, 0, and 0, or they may be set in real-time.

As still yet another example, the (9_1)-st item type candidates (e.g., weapon A, weapon D, armor B, armor E) to the (9_4)-th item type candidates (e.g., weapon B, weapon D, armor C, armor E) may be set as the item type candidates corresponding to the game-progression degree satisfying the triggering point that is needed to enter into the ninth stage or they may be set in real-time as the item type candidates corresponding to the game-progression degree satisfying the triggering point that is needed to enter into the ninth stage, such that they are selected from the predetermined time period which follows a predicted time point of satisfying the triggering point that is needed to enter into the ninth stage. For example, the (9_1)-st item type probabilities to the (9_4)-th item type probabilities may be set as 0.15, 0.25, 0.4, and 0.2, or they may be set in real-time.

Further, similar to descriptions of the item type candidates and their corresponding item type probabilities, it is possible to set item type performance candidates and their corresponding item performance probabilities for each game-progression degree. For example, (1_1)-st item performance candidates (e.g., 120% performance for a base performance of at least some items) to (1_5)-th item performance candidates (e.g., 80% performance for the base performance of at least some items) may be set as the item performance candidates corresponding to the game-progression degree satisfying the triggering point that is needed to enter into the first stage or they may be set in real-time as the item performance candidates corresponding to the game-progression degree satisfying the triggering point that is needed to enter into the first stage, such that they are selected from the predetermined time period which follows the time point of satisfying the triggering point that is needed to enter into the first stage. For example, (1_1)-st item performance probabilities to (1_5)-th item performance probabilities may be set as 0.15, 0.2, 0.4, 0.2 and 0.05, or they may be set in real-time.

As another example, it is possible to predict the time point of satisfying the triggering point that is needed to enter into the first stage, therefore, the (1_1)-st item performance candidates (e.g., 120% performance for the base performance of at least some items) to the (1_5)-th item performance candidates (e.g., 80% performance for the base performance of at least some items) may be set as the item performance candidates corresponding to the game-progression degree satisfying the triggering point that is needed to enter into the first stage or they may be set in real-time as the item performance candidates corresponding to the game-progression degree satisfying the triggering point that is needed to enter into the first stage, such that they are selected from the predetermined time period which follows the predicted time point of satisfying the triggering point that is needed to enter into the first stage. For example, the (1_1)-st item performance probabilities to the (1_5)-th item performance probabilities may be set as 0, 0, 1, 0, and 0, or they may be set in real-time. It is noted that all probabilities may be set to be non-zeros.

As still another example, (9_1)-st item performance candidates (e.g., 150% performance for the base performance of at least some items) to (9_4)-th item performance candidates (e.g., 120% performance for the base performance of at least some items) may be set as the item performance candidates corresponding to the game-progression degree satisfying the triggering point that is needed to enter into the ninth stage or they may be set in real-time as the item performance candidates corresponding to the game-progression degree satisfying the triggering point that is needed to enter into the ninth stage, such that they are selected from the predetermined time period which follows the time point of satisfying the triggering point that is needed to enter into the ninth stage. For example, (9_1)-st item performance probabilities to (9_4)-th item performance probabilities may be set as 0, 1, 0, and 0, or they may be set in real-time.

As still yet another example, the (9_1)-st item performance candidates (e.g., 150% performance for the base performance of at least some items) to the (9_4)-th item performance candidates (e.g., 120% performance for the base performance of at least some items) may be set as the item performance candidates corresponding to the game-progression degree satisfying the triggering point that is needed to enter into the ninth stage or they may be set in real-time as the item performance candidates corresponding to the game-progression degree satisfying the triggering point that is needed to enter into the ninth stage, such that they are selected from the predetermined time period which follows the predicted time point of satisfying the triggering point that is needed to enter into the ninth stage. For example, the (9_1)-st item performance probabilities to the (9_4)-th item performance probabilities may be set as 0.15, 0.25, 0.4, and 0.2, or they may be set in real-time.

As such, on condition that the server 100 has set and managed at least part of (i) item type candidates and their corresponding item type probabilities for each game-progression degree and (ii) item performance candidates and their corresponding item performance probabilities for each game-progression degree, the server 100 may determine whether the specific game-progression degree acquired by the progress calculating function in real-time at the second state satisfies the predetermined condition.

For example, the server 100 may determine whether the triggering point is satisfied by referring to at least part of factors such as the elapsed time information, the player battle power information, the area phase information, the cardinal number of surviving players, and the possessed item of the surviving players corresponding to the specific game-progression degree or any combination thereof.

For instance, on condition that “1000”, “first phase”, and “80” have been set as triggering points of average player battle power information, the area phase information, and the cardinal number of surviving players respectively, (i) in case at least part of the item types and the item performances is changed for a first time and (ii) in case the average battle power information, the area phase information, and the cardinal number of surviving players corresponding to the specific game-progression degree acquired by the progress calculating function are determined as “1200”, “first phase”, and “75” respectively in real time, the server 100 may determine that the specific game-progression degree is satisfying the predetermined condition. It is appreciated that not all triggering factors mentioned above should be satisfied but depending on different situations a satisfaction of some combination of the triggering factors may be enough to satisfy the predetermined condition.

As another example, on condition that “2000” has been set as the triggering point corresponding to a combination (that is, a function value) of the average player battle power information, the area phase information, and the cardinal number of surviving players, (i) in case at least part of the item types and the item performances is changed for the first time and (ii) in case the combination of the average player battle power information, the area phase information, and the cardinal number of surviving players acquired by using the progress calculating function in real time are determined as “2500”, the server 100 may determine that the specific game-progression degree satisfies the predetermined condition.

As still another example, on condition that “1500”, “second phase”, and “50” have been set as the triggering points of average player battle power information, the area phase information, and the cardinal number of surviving players respectively, (i) in case at least part of the item types and the item performances is changed for a first time and (ii) in case the average battle power information, the area phase information, and the cardinal number of surviving players corresponding to the specific game-progression degree acquired by using the progress calculating function in real time are determined as 1450, the first phase, and 55 respectively, even though the triggering points are not met yet, because the triggering points will be satisfied within a short period, the server 100 may predict a timing of satisfying the triggering points with reference to the amount of change and the change rate for each of the triggering factors.

Further, in response to determining that the predetermined condition is satisfied as explained above, the server 100 may check at least part of (i) the specific item type candidates and their corresponding specific item type probabilities, and (ii) the specific item performance candidates and their corresponding specific item performance probabilities, which correspond to the specific game-progression degree. As mentioned above, the “probabilities” herein may be an exact numerical value recorded on a database, but they may be determined to be within a predetermined range.

Further, the server 100 may change at least part of the item types or the item performances of the battle royale game by referring to at least part of (i) the specific item types calculated by using the predetermined first function whose arguments include the specific item type candidates and their corresponding specific item type probabilities and (ii) the specific item performances calculated by using a predetermined second function whose arguments include the specific item performance candidates and their corresponding specific item performance probabilities.

Hereinafter, processes of selecting the specific item types and the specific item performances will be explained by using examples of the game-progression degree satisfying the triggering point that is needed to enter into the first stage, and the game-progression degree satisfying the triggering point that is needed to enter into the ninth stage.

For example, in response to determining that the specific game-progression degree acquired by using the progress calculating function in real-time at the second state satisfies the triggering point that is needed to enter into the first stage, the server 100 may determine a (1_3)-rd item type candidates (e.g., weapon A, weapon D, armor B, armor D), which corresponds to the highest probability of 0.4, as the specific item types, by using the predetermined first function whose arguments are (i) the (1_1)-st item type candidates (e.g., weapon A, weapon C, armor A, armor B) to the (1_5)-th item type candidates (e.g., weapon A, weapon B, armor B, armor D) and (ii) their corresponding (1_1)-st item type probabilities to the (1_5)-th item type probabilities (e.g., 0.15, 0.2, 0.4, 0.2, and 0.05).

It is to be appreciated that, unlike above, the server 100 may select the (1_5)-th item type candidates (e.g., weapon A, weapon B, armor B, armor D) which has the lowest probability of 0.05 as the specific item types.

As another example, in response to determining that the specific game-progression degree acquired by using the progress calculating function in real-time at the second state satisfies the triggering point that is needed to enter into the ninth stage, the server 100 may determine a (9_3)-rd item type candidates (e.g., weapon B, weapon C, armor A, armor E), which corresponds to the highest probability of 0.4, as the specific item types, by using the predetermined first function whose arguments are (i) the (9_1)-st item type candidates (e.g., weapon A, weapon D, armor B, armor E) to a (9_4)-th item type candidates (e.g., weapon B, weapon D, armor C, armor E) and (ii) their corresponding (9_1)-st item type probabilities to the (9_4)-th item type probabilities (e.g., 0.15, 0.25, 0.4, and 0.2).

It is to be noted that the specific item performances can be determined in a similar manner as above.

Also, the server 100 may change at least part of the item types and the item performances used within the battle royale game by referring to the specific item types and the specific item performances by the above processes.

Till now, a method of the server 100 changing at least part of the item types and the item performances was explained, hereinafter, example embodiments of the server 100 providing the battle royale game capable of allowing the item types and the item performances to be changed by referring to the game-progression degree will be given.

For example, on condition that at least part of metadata related to a 1-st weight, a 2-nd weight, a 3-rd weight, a 4-th weight, and a 5-th weight has been managed, wherein the 1-st weight is applied to the elapsed time information, the 2-nd weight is applied to the player battle power information, the 3-rd weight is applied to the area phase information, the 4-th weight is applied to the cardinal number of the surviving players, and the 5-th weight is applied to the possessed items of the surviving players, in response to determining that a weighted specific game-progression degree satisfies the predetermined condition, wherein the weighted specific game-progression degree is acquired from the progress calculating function in real-time at the second state by applying at least part of the 1-st weight to the 5-th weight to the elapsed time information, the player battle power information, the area phase information, the cardinal number of surviving players, and the possessed items of the surviving players corresponding to the specific game-progression degree, the server 100 may check at least part of (i) the specific item type candidates and their corresponding specific item type probabilities, and (ii) the specific item performance candidates and their corresponding specific item performance probabilities that are matched with the weighted specific game-progression degree.

Herein, the server 100 may (i) determine a specific factor, whose rate of change within a specific time period is greater than or equal to a threshold rate of change, among entire factors (i.e., among the player battle power information, the area phase information, the cardinal number of surviving players, and the possessed items of the surviving players), and (ii) set a specific weight corresponding to the specific factor to be greater than other weights corresponding to other factors.

It is to be noted that the specific time period, among a plurality of predetermined time periods, may correspond to a specific time point when the specific game-progression degree is acquired, and said other factors may be factors excluding the specific factor among the entire factors.

As an example, for the possessed items of the surviving players among factors corresponding to the game-progression degree, in order to prevent a situation of a monotonous game flow due to the surviving players using a same item, at least part of the item types and the item performances may be changed at appropriate times, that is, in a situation where 80% or more of the surviving players possess a specific short-range weapon, at least part of the item type candidates and their corresponding item type probabilities, and the item performance candidates and their corresponding item performance probabilities may be set and managed.

During the above situation, in response to acquiring information on the possessed items of the surviving players (e.g., information that 50% of the surviving players are possessing the same specific short-range weapon), the server 100 may (i) determine the specific game-progression degree by using the progress calculating function with the possessed items of the surviving players as its argument, and (ii) check at least part of the specific item type candidates and their corresponding specific item type probabilities corresponding to the specific game-progression degree, and specific item performance candidates and their corresponding specific item performance probabilities corresponding to the specific game-progression degree. Further, since the current situation does not correspond to a situation in which at least part of the item types and the item performances has to be changed (because 80% or more of the surviving players do not possess the specific short-range weapon) the server 100 may not change the item types and the item performances.

On the other hand, in response to acquiring information on the possessed items of the surviving players (e.g., information that 85% of the surviving players are possessing the same specific short-range weapon), the server 100 may (i) determine the specific game-progression degree by using the progress calculating function with the possessed items of the surviving players as its argument, and (ii) check at least part of the specific item type candidates and their corresponding specific item type probabilities, and specific item performance candidates and their corresponding specific item performance probabilities of the specific game-progression degree. Further, since the current situation corresponds to a situation in which at least part of the item types and the item performances has to be changed (because 80% or more of the surviving players possess the specific short-range weapon), the server 100 may change the item types and the item performances.

Meanwhile, at least part of the entire area of the battle royale game may be partitioned based on geographical information, and the server 100 may manage each game-progression degree for each area.

For example, the server 100 may manage each of a 1-st game-progression degree to an m-th game-progression degree for each of a 1-st area to an m-th area respectively, wherein the 1-st area to the m-th area are acquired by dividing at least part of the entire area (including the safe area and the dangerous area) based on the geographical information.

Further, the server 100 may have set and managed at least part of (i) 1-st item type candidates to m-th item type candidates and their corresponding 1-st item type probabilities to m-th item type probabilities for the 1-st area to the m-th area respectively, and (ii) 1-st item performance candidates to m-th item performance candidates and their corresponding 1-st item performance probabilities to m-th item performance probabilities for the 1-st area to the m-th area respectively.

Furthermore, the server 100 may determine whether at least part of a 1-st specific game-progression degree to an m-th specific game-progression degree acquired by using the progress calculating function in real-time at the second state satisfies at least part of a 1-st predetermined condition to an m-th predetermined condition respectively.

It is to be appreciated that at least part of the 1-st specific game-progression degree to the m-th specific game-progression degree may be different from each other, however, they are not limited thereto. For instance, at least part of the 1-st specific game-progression degree to the m-th specific game-progression degree may be identical.

For instance, in response to determining that at least part of the 1-st specific game-progression degree to the m-th specific game-progression degree satisfies at least part of the 1-st predetermined condition to the m-th predetermined condition respectively, the server 100 may check at least part of (1) 1-st specific item type candidates to m-th specific item type candidates and their corresponding 1-st specific item type probabilities to m-th specific item type probabilities for the 1-st area to the m-th area respectively, and (2) 1-st specific item performance candidates to m-th specific item performance candidates and their corresponding 1-st specific item performance probabilities to m-th specific item performance probabilities for the 1-st area to the m-th area respectively. Herein, the 1-st area to the m-th area are respectively matched with the 1-st specific game-progression degree to the m-th specific game-progression degree.

It is noted that each of the 1-st specific game-progression degree to the m-th specific game-progression degree for each of the 1-st area to the m-th area may be calculated by using the progress calculating function whose arguments are at least part of (i) each of 1-st specific elapsed time information to m-th specific elapsed time information, (ii) each of 1-st specific player battle power information to m-th specific player battle power information, (iii) each of a 1-st cardinal number of surviving players to an m-th cardinal number of surviving players, (iv) each of 1-st specific area phase information to m-th specific area phase information, and (v) 1-st specific possessed items of the surviving players to m-th specific possessed items of the surviving players.

Further, the server 100 may refer to at least part of (i) 1-st specific item types to m-th specific item types which are respectively acquired by using a predetermined (1_1)-st function whose arguments are the 1-st specific item type candidates and their corresponding 1-st specific item type probabilities to a predetermined (1_m)-th function whose arguments are the m-th specific item type candidates and their corresponding m-th specific item type probabilities, and (ii) 1-st specific item performances to m-th specific item performances which are respectively acquired by using a predetermined (2_1)-st function whose arguments are the 1-st specific item performance candidates and their corresponding 1-st specific item performance probabilities to a predetermined (2_m)-th function whose arguments are the m-th specific item performance candidates and their corresponding m-th specific item performance probabilities, to thereby change at least part of the item types and the item performances.

Meanwhile, the server 100 may determine a 1-st surviving player group to an n-th surviving player group by referring to classes applied to specific surviving players and specific possessed items of the specific surviving players.

For reference, the 1-st surviving player group to the n-th surviving player group may be determined by classifying each of the surviving players based on at least part of classes applied thereto and the possessed items thereof.

For example, among 40 specific surviving players, if a 1-st class is applied to 20 surviving players, a 2-nd class is applied to 10 surviving players, and a 3-rd class is applied to 10 surviving players, the server 100 may refer to classes of the 40 specific surviving players, to thereby classify the 40 specific surviving players into (i) the 1-st surviving player group of the 20 surviving players with the 1-st class, (ii) a 2-nd surviving player group of the 10 surviving players with the 2-nd class, and (iii) a 3-rd surviving player group of the 10 surviving players with the 3-rd class.

As another example, on condition that, among the 40 specific surviving players, the 1-st class is applied to the 20 surviving players, and the 2-nd class is applied to the 10 surviving players, and the 3-rd class is applied to the 10 surviving players, if (1) among the surviving players with the 1-st class, 10 surviving players possess short-range weapons, and remaining 10 surviving players possess long-range weapons, (2) among the surviving players with the 2-nd class, 6 surviving players possess the short-range weapons, and remaining 4 surviving players possess the long-range weapons, and (3) among the surviving players with the 3-rd class, 3 surviving players possess the short-range weapons, and remaining 7 players possess the long-range weapons, the server 100 may refer to the classes and the possessed items of the 40 specific surviving players, to thereby classify each of the 40 specific surviving players into one of (i) the 1-st surviving player group, i.e., the 10 surviving players which have the 1-st class and possess the short-range weapons, (ii) the 2-nd surviving player group, i.e., the 10 surviving players which has the 1-st class and possess the long-range weapons, (iii) the 3-rd surviving player group, i.e., the 6 surviving players which have the 2-nd class and possess the short-range weapons, (iv) the 4-th surviving player group, i.e., the 4 surviving players which have the 2-nd class and possess the long-range weapons, (v) a 5-th surviving player group, i.e., the 3 surviving players which have the 3-rd class and possess the short-range weapons, and (vi) a 6-th surviving player group, i.e., the 7 surviving players which have the 3-rd class and possess the long-range weapons.

Further, the server 100 may change the item types and item performances of one or more k-th class synergy items corresponding to a k-th surviving player group, which satisfies a threshold condition of the surviving players, among the 1-st surviving player group to the n-th surviving player group.

For reference, the k-th class synergy items may be items capable of amplifying the item performances when used by a corresponding k-th surviving player with a k-th class.

Meanwhile, on condition that the server 100 has changed at least part of the item types and the item performances of the battle royale game by referring to the specific item types and the specific item performances, the server 100 may transmit item type changed information and item performance changed information to at least part of users.

For example, with reference to FIG. 3, the server 100 may transmit at least part of the item type changed information and the item performance changed information to a specific user device of a specific surviving player, to thereby instruct the specific user device to display at least part of the item type changed information and the item performance changed information onto at least part of (i) a 1-st display area 2000_1 for displaying azimuth information, (ii) a 2-nd display area 2000_2 for displaying field location information of the specific surviving player, (iii) a 3-rd display area 2000_3 for displaying map location information of the specific surviving player, and (iv) a 4-th display area (not illustrated) for displaying the specific possessed item of the specific surviving player.

By implementing the above configurations, the server 100 may allow a plurality of players to change at least part of the item types and the item performances by referring to the game-progression degree, thereby sustaining interests of the players.

The present disclosure has an effect of providing the battle royale game capable of allowing at least part of the item types and the item performances to be changed by referring to the game-progression degree.

The present disclosure has another effect of enabling users of the battle royale game to continuously have interests in the battle royale game.

The embodiments of the present disclosure as explained above can be implemented in a form of executable program command through a variety of computer means recordable to computer readable media. The computer readable media may include solely or in combination, program commands, data files, and data structures. The program commands recorded to the media may be components specially designed for the present disclosure or may be usable to a skilled human in a field of computer software. Computer readable media include magnetic media such as hard disk, floppy disk, and magnetic tape, optical media such as CD-ROM and DVD, magneto-optical media such as floptical disk and hardware devices such as ROM, RAM, and flash memory specially designed to store and carry out program commands. Program commands may include not only a machine language code made by a complier but also a high level code that can be used by an interpreter etc., which is executed by a computer. The aforementioned hardware device can work as more than a software module to perform the action of the present disclosure and they can do the same in the opposite case.

As seen above, the present disclosure has been explained by specific matters such as detailed components, limited embodiments, and drawings. They have been provided only to help more general understanding of the present disclosure. It, however, will be understood by those skilled in the art that various changes and modification may be made from the description without departing from the spirit and scope of the disclosure as defined in the following claims.

Accordingly, the thought of the present disclosure must not be confined to the explained embodiments, and the following patent claims as well as everything including variations equal or equivalent to the patent claims pertain to the category of the thought of the present disclosure.

What is claimed is:

1. A method of providing a battle royale game capable of allowing at least part of one or more item types and item performances to be changed by referring to a game-progression degree, wherein the battle royale game is a game in which a plurality of players compete for survival in a specific area, wherein a first state of the battle royale game represents a standby state in which the players log into the battle royale game and wait in a same waiting space and wherein a second state of the battle royale game represents a state in which the players play the battle royale game, comprising steps of:
(a) on condition that at least part of respective item type candidates and their corresponding item type probabilities, and respective item performance candidates and their corresponding item performance probabilities for each game-progression degree have been set and managed, wherein the game-progression degree is calculated by using a progress calculating function whose arguments include at least part of (i) elapsed time information which represents a time elapsed after the battle royale game enters the second state, (ii) player battle power information which represents battle powers of at least part of the plurality of players, (iii) a cardinal number of surviving players among the plurality of players, (iv) area phase information which represents a state of a safe area and a dangerous area being changed according to area metadata, and (v) possessed items of the surviving players, in response to detecting that a specific game-progression degree acquired by using the progress calculating function in real-time at the second state satisfies a predetermined condition, a server checking at least part of specific item type candidates and their corresponding specific item type probabilities, and specific item performance candidates and their corresponding specific item performance probabilities corresponding to the specific game-progression degree; and
(b) the server changing at least part of the item types or the item performances of the battle royale game by referring to at least part of (i) specific item types calculated by using a predetermined first function whose arguments include the specific item type candidates and their corresponding specific item type probabilities and (ii) specific item performances calculated by using a predetermined second function whose arguments include the specific item performance candidates and their corresponding specific item performance probabilities.

2. The method of claim 1, wherein, at the step of (a), on condition that the server has managed each of a 1-st game-progression degree to an m-th game-progression degree for each of a 1-st area to an m-th area respectively, wherein the 1-st area to the m-th area are acquired by dividing an entire area including the safe area and the dangerous area based on geographical information, and has set and managed at least part of (i) 1-st item type candidates to m-th item type candidates and their corresponding 1-st item type probabilities to m-th item type probabilities for the 1-st area to the m-th area respectively, and (ii) 1-st item performance candidates to m-th item performance candidates and their corresponding 1-st item performance probabilities to m-th item performance probabilities for the 1-st area to the m-th area respectively, the server, in response to determining that at least part of a 1-st specific game-progression degree to an m-th specific game-progression degree acquired by using the progress calculating function in real-time at the second state satisfies at least part of a 1-st predetermined condition to an m-th predetermined condition respectively, checks at least part of (1) 1-st specific item type candidates to m-th specific item type candidates and their corresponding 1-st specific item type probabilities to m-th specific item type probabilities for the 1-st area to the m-th area respectively, and (2) 1-st specific item performance candidates to m-th specific item performance candidates and their corresponding 1-st specific item performance probabilities to m-th specific item performance probabilities for the 1-st area to the m-th area respectively, wherein the 1-st area to the m-th area are respectively matched with the 1-st specific game-progression degree to the m-th specific game-progression degree, and
wherein, at the step of (b), the server refers to at least part of (i) 1-st specific item types to m-th specific item types which are respectively acquired by using a predetermined (1_1)-st function whose arguments are the 1-st specific item type candidates and their corresponding 1-st specific item type probabilities to a predetermined (1_m)-th function whose arguments are the m-th specific item type candidates and their corresponding m-th specific item type probabilities, and (ii) 1-st specific item performances to m-th specific item performances which are respectively acquired by using a predetermined (2_1)-st function whose arguments are the 1-st specific item performance candidates and their corresponding 1-st specific item performance probabilities to a predetermined (2_m)-th function whose arguments are the m-th specific item performance candidates and their corresponding m-th specific item performance probabilities, to thereby change at least part of the item types and the item performances.

3. The method of claim 2, wherein each of the 1-st specific game-progression degree to the m-th specific game-progression degree for each of the 1-st area to the m-th area is calculated by using the progress calculating function whose arguments are at least part of (i) each of 1-st specific elapsed time information to m-th specific elapsed time information, (ii) each of 1-st specific player battle power information to m-th specific player battle power information, (iii) each of a 1-st cardinal number of surviving players to an m-th cardinal number of surviving players, (iv) each of 1-st specific area phase information to m-th specific area phase information, and (v) 1-st specific possessed items of the surviving players to m-th specific possessed items of the surviving players.

4. The method of claim 1, wherein, at the step of (b), the server changes at least part of the item types and the item performances used within the battle royale game by referring to at least part of the specific item types and the specific item performances, wherein the server changes the item types and item performances of one or more k-th class synergy items corresponding to a k-th surviving player group, which satisfies a threshold condition of surviving players, among a 1-st surviving player group to an n-th surviving player group, wherein the 1-st surviving player group to the n-th surviving player group are determined by classifying the surviving players based on at least part of classes applied thereto and the possessed items thereof, and wherein the k-th class synergy items are items capable of amplifying the item performances when used by a corresponding k-th surviving player with a k-th class.

5. The method of claim 1, wherein, at the step of (a), on condition that at least part of metadata related to a 1-st weight, a 2-nd weight, a 3-rd weight, a 4-th weight, and a 5-th weight has been managed, wherein the 1-st weight is applied to the elapsed time information, the 2-nd weight is applied to the player battle power information, the 3-rd weight is applied to the area phase information, the 4-th weight is applied to the cardinal number of the surviving players, and the 5-th weight is applied to the possessed items of the surviving players, in response to determining that a weighted specific game-progression degree satisfies the predetermined condition, wherein the weighted specific game-progression degree is acquired from the progress calculating function in real-time at the second state by applying at least part of the 1-st weight to the 5-th weight to the elapsed time information, the player battle power information, the area phase information, the cardinal number of surviving players, and the possessed items of the surviving players corresponding to specific game-progression degree, the server checks at least part of (i) the specific item type candidates and their corresponding specific item type probabilities, and (ii) the specific item performance candidates and their corresponding specific item performance probabilities that are matched with the weighted specific game-progression degree.

6. The method of claim 5, wherein, at the step of (a), the server (i) determines a specific factor, among entire factors, whose rate of change within a specific time period is greater than or equal to a threshold rate of change, wherein the specific time period, among a plurality of predetermined time periods, corresponds to a specific time point when the specific game-progression degree is acquired, and (ii) sets a specific weight corresponding to the specific factor to be greater than other weights corresponding to other factors, wherein said other factors are factors excluding the specific factor among the entire factors, and wherein the entire factors include the player battle power information, the area phase information, the cardinal number of surviving players, and the possessed items of the surviving players.

7. The method of claim 1, wherein, at the step of (b), the server changes at least part of the item types and the item performances of one or more items used within the battle royale game by referring to at least part of the specific item types and the specific item performances,
wherein, the server transmits at least part of item type changed information and item performance changed information to a specific user device of a specific surviving player, to thereby instruct the specific user device to display at least part of the item type changed information and the item performance changed information onto at least part of (i) a 1-st display area for displaying azimuth information, (ii) a 2-nd display area for displaying field location information of the specific surviving player, (iii) a 3-rd display area for displaying map location information of the specific surviving player, and (iv) a 4-th display area for displaying a specific possessed item of the specific surviving player.

8. A server of providing a battle royale game capable of allowing at least part of one or more item types and item performances to be changed by referring to a game-progression degree, wherein the battle royale game is a game in which a plurality of players compete for survival in a specific area, wherein a first state of the battle royale game represents a standby state in which the players log into the battle royale game and wait in a same waiting space and wherein a second state of the battle royale game represents a state in which the players play the battle royale game, comprising:
at least one memory that stores instructions; and
at least one processor configured to execute the instructions to perform or support another device to perform processes of: (I) on condition that at least part of respective item type candidates and their corresponding item type probabilities, and respective item performance candidates and their corresponding item performance probabilities for each game-progression degree have been set and managed, wherein the game-progression degree is calculated by using a progress calculating function whose arguments include at least part of (i) elapsed time information which represents a time elapsed after the battle royale game enters the second state, (ii) player battle power information which represents battle powers of at least part of the plurality of players, (iii) a cardinal number of surviving players among the plurality of players, (iv) area phase information which represents a state of a safe area and a dangerous area being changed according to area metadata, and (v) possessed items of the surviving players, in response to detecting that a specific game-progression degree acquired by using the progress calculating function in real-time at the second state satisfies a predetermined condition, checking at least part of specific item type candidates and their corresponding specific item type probabilities, and specific item performance candidates and their corresponding specific item performance probabilities corresponding to the specific game-progression degree; and (II) changing at least part of the item types or the item performances of the battle royale game by referring to at least part of (i) specific item types calculated by using a predetermined first function whose arguments include the specific item type candidates and their corresponding specific item type probabilities and (ii) specific item performances calculated by using a predetermined second function whose arguments include the specific item performance candidates and their corresponding specific item performance probabilities.

9. The server of claim 8, wherein, at the process of (I), on condition that the processor has managed each of a 1-st game-progression degree to an m-th game-progression degree for each of a 1-st area to an m-th area respectively, wherein the 1-st area to the m-th area are acquired by dividing an entire area including the safe area and the dangerous area based on geographical information, and has set and managed at least part of (i) 1-st item type candidates to m-th item type candidates and their corresponding 1-st item type probabilities to m-th item type probabilities for the 1-st area to the m-th area respectively, and (ii) 1-st item performance candidates to m-th item performance candidates and their corresponding 1-st item performance probabilities to m-th item performance probabilities for the 1-st area to the m-th area respectively, the processor, in response to determining that at least part of a 1-st specific game-progression degree to an m-th specific game-progression degree acquired by using the progress calculating function in real-time at the second state satisfies at least part of a 1-st predetermined condition to an m-th predetermined condition respectively, checks at least part of (1) 1-st specific item type candidates to m-th specific item type candidates and their corresponding 1-st specific item type probabilities to m-th specific item type probabilities for the 1-st area to the m-th area respectively, and (2) 1-st specific item performance candidates to m-th specific item performance candidates and their corresponding 1-st specific item performance probabilities to m-th specific item performance probabilities for the 1-st area to the m-th area respectively, wherein the 1-st area to the m-th area are respectively matched with the 1-st specific game-progression degree to the m-th specific game-progression degree, and wherein, at the step of (II), the processor refers to at least part of (i) 1-st specific item types to m-th specific item types which are respectively acquired by using a predetermined (1_1)-st function whose arguments are the 1-st specific item type candidates and their corresponding 1-st specific item type probabilities to a predetermined (1_m)-th function whose arguments are the m-th specific item type candidates and their corresponding m-th specific item type probabilities, and (ii) 1-st specific item performances to m-th specific item performances which are respectively acquired by using a predetermined (2_1)-st function whose arguments are the 1-st specific item performance candidates and their corresponding 1-st specific item performance probabilities to a predetermined (2_m)-th function whose arguments are the m-th specific item performance candidates and their corresponding m-th specific item performance probabilities, to thereby change at least part of the item types and the item performances.

10. The server of claim 9, wherein each of the 1-st specific game-progression degree to the m-th specific game-progression degree for each of the 1-st area to the m-th area is calculated by using the progress calculating function whose arguments are at least part of (i) each of 1-st specific elapsed time information to m-th specific elapsed time information, (ii) each of 1-st specific player battle power information to m-th specific player battle power information, (iii) each of a 1-st cardinal number of surviving players to an m-th cardinal number of surviving players, (iv) each of 1-st specific area phase information to m-th specific area phase information, and (v) 1-st specific possessed items of the surviving players to m-th specific possessed items of the surviving players.

11. The server of claim 8, wherein, at the process of (II), the processor changes at least part of the item types and the item performances used within the battle royale game by referring to at least part of the specific item types and the specific item performances, wherein the processor changes the item types and item performances of one or more k-th class synergy items corresponding to a k-th surviving player group, which satisfies a threshold condition of surviving players, among a 1-st surviving player group to an n-th surviving player group, wherein the 1-st surviving player group to the n-th surviving player group are determined by classifying the surviving players based on at least part of classes applied thereto and the possessed items thereof, and wherein the k-th class synergy items are items capable of amplifying the item performances when used by a corresponding k-th surviving player with a k-th class.

12. The server of claim 8, wherein, at the process of (I), on condition that at least part of metadata related to a 1-st weight, a 2-nd weight, a 3-rd weight, a 4-th weight, and a 5-th weight has been managed, wherein the 1-st weight is applied to the elapsed time information, the 2-nd weight is applied to the player battle power information, the 3-rd weight is applied to the area phase information, the 4-th weight is applied to the cardinal number of the surviving players, and the 5-th weight is applied to the possessed items of the surviving players, in response to determining that a weighted specific game-progression degree satisfies the predetermined condition, wherein the weighted specific game-progression degree is acquired from the progress calculating function in real-time at the second state by applying at least part of the 1-st weight to the 5-th weight to the elapsed time information, the player battle power information, the area phase information, the cardinal number of surviving players, and the possessed items of the surviving players corresponding to specific game-progression degree, the processor checks at least part of (i) the specific item type candidates and their corresponding specific item type probabilities, and (ii) the specific item performance candidates and their corresponding specific item performance probabilities that are matched with the weighted specific game-progression degree.

13. The server of claim 12, wherein, at the process of (I), the processor (i) determines a specific factor, among entire factors, whose rate of change within a specific time period is greater than or equal to a threshold rate of change, wherein the specific time period, among a plurality of predetermined time periods, corresponds to a specific time point when the specific game-progression degree is acquired, and (ii) sets a specific weight corresponding to the specific factor to be greater than other weights corresponding to other factors, wherein said other factors are factors excluding the specific factor among the entire factors, and wherein the entire factors include the player battle power information, the area phase information, the cardinal number of surviving players, and the possessed items of the surviving players.

14. The server of claim 8, wherein, at the process of (II), the processor changes at least part of the item types and the item performances of one or more items used within the battle royale game by referring to at least part of the specific item types and the specific item performances, wherein, the processor transmits at least part of item type changed information and item performance changed information to a specific user device of a specific surviving player, to thereby instruct the specific user device to display at least part of the item type changed information and the item performance changed information onto at least part of (i) a 1-st display area for displaying azimuth information, (ii) a 2-nd display area for displaying field location information of the specific surviving player, (iii) a 3-rd display area for displaying map location information of the specific surviving player, and (iv) a 4-th display area for displaying a specific possessed item of the specific surviving player.
